(19) United States
(12) Patent Application Publication
(10) Pub. No.: US 2002/0117013 A1
(43) Pub. Date: Aug. 29, 2002

(54) Variable geometry fluid sample loader

(75) Inventor: Branko Bem, Newark, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DNA Sciences, Inc., Fremont, CA

(21) Appl. No.: 10/005,848

(22) Filed: Oct. 25, 2001

Related U.S. Application Data
(60) Provisional application No. 60/243,313, filed on Oct. 25, 2000.

(51) Int. Cl. G01N 1/10

(52) U.S. Cl. 73/864.25; 436/180

(57) ABSTRACT

The present invention provides systems and methods for transferring small volume liquid samples between a microtiter plate or block having wells arranged in a given configuration to a plate or block having wells arranged in a differing configuration. In particular, the present invention provides systems and methods for transferring such liquid samples between a standard rectangular microtiter sample reaction/storage block having wells arranged in straight rows and a circular microchannel plate (MCP) having wells arranged in an arc. The system comprises a plurality of moveable arms, wherein each arm is adapted to hold a fluid sample dispensing tube having a distal end. The arms are positionable so that the distal ends of the held tubes can simultaneously access wells arranged in a substantially straight row, such as wells in a standard rectangular 96, 384, 1536 or 3456 well microtiter block. This allows the tubes to extract or aspirate the liquid from the wells. The arms are then repositionable or moveable so that the distal ends of the held tubes can be repositioned to simultaneously access wells arranged in an arc, such as loading wells in a circular MCP.

### CROSS-REFERENCES TO RELATED APPLICATIONS

This application claims the benefit of priority from Provisional Application No. 60/243,313, filed on Oct. 25, 2000 (Attorney Docket No. 019553-003600US), the full disclosure of which is incorporated herein by reference.

### STATEMENT AS TO RIGHTS TO INVENTIONS MADE UNDER

### FEDERALLY SPONSORED RESEARCH OR DEVELOPMENT

NOT APPLICABLE

### REFERENCE TO A “SEQUENCE LISTING,” A TABLE, OR A COMPUTER

### PROGRAM LISTING APPENDIX SUBMITTED ON A COMPACT DISK.

NOT APPLICABLE

### BACKGROUND OF THE INVENTION

Diagnostic and other biological assays often require systems for metering, dispensing and mixing agents with sample fluids. The sample fluids may include, for example, patient samples, blood samples, or minute quantities of the oxygenated ribonucleic acid (DNA) sequences in a buffer fluid. Both manual and automated systems have been available for aliquoting the fluid samples, and assaying the samples with one or more reagents. Manual systems have historically included the glass capillary pipette, the micropipette, precision syringes and weighing equipment. A variety of biological assays have been and continue to be conducted with manual equipment of the type described.

Relatively sophisticated microbiological assays including micro-enzyme linked immunosorbent sandwich assays (ELISA) can be satisfactorily, if tediously, performed manually. The demands of modern antibody/antigen matching, histocompatibility typing, paternity testing, etc. on a vast scale has precipitated the development of various automated assay equipment to more quickly process large numbers of patient samples with various reagents. It is apparent that in order to perform a multiplicity of assays with a single patient's sample, the amount of sample must be relatively large, or a small sample must be aliquoted into smaller divisions.

As a result, automated liquid-handling systems have been developed for quick pipetting, diluting and dispensing operations. Examples include the Biomek 2000 Laboratory Automation Workstation (Beckman Coulter, Inc.) and the PlateMate Plus™ (Matrix Technologies Corp.). In general, these types of systems provide for reagent addition, assay and mother-daughter plate production, serial dilution and plate reformatting needs in microplates having 96, 384, and/or 1536 well configurations. These well configurations are rectangular in which the wells are aligned in straight rows. Pipette tools can aspirate solution from wells of one microplate and expel the solution in wells of another microplate, either by computer controlled movement of the microplates or of the pipette tools. It is relatively simple to transfer fluid between the different sized microplates since they all have the same geometry, namely rectangular.

However, a number of biological assays require the use of electrophoresis. Electrophoresis is an analytical technique to separate and identify charged particles, ions, or molecules. Molecules are separated by their different mobilities under an applied electric field. The mobilities variation derives from the different charge and frictional resistance characteristics of the molecules. When a mixture containing several molecular species is introduced into the electrophoretic separation channel and an electric field is applied, the different charge components migrate at various speeds in the system leading to the resolution of the mixture. Bands appear, depending on the mobilities of the components.

Microchannel plates (MCPs) have been developed to provide a quick, efficient and compact means for running electrophoretic assays. However, MCPs may vary in shape depending on their design and layout of electrophoretic separation channels. Some MCPs are round or oval in shape having wells for loading sample arranged along the outside edge of the plate, i.e. in an arc or circular arrangement. Consequently, such MCPs are incompatible for use with the above described automated liquid-handling systems in that the pipette tools are unable to transfer liquid from a standard rectangular microplate to a MCP of non-rectangular geometry.

Therefore, a need exists for a high-precision, small volume fluid processing system which can at least transfer fluid samples in extremely small volumes between plates having wells in various geometries. The system should also preferably be relatively highly automated so that the incidence of human error is reduced.

### BRIEF SUMMARY OF THE INVENTION

The present invention provides systems and methods for transferring small volume liquid samples between a microtiter plate or block having wells arranged in a given configuration to a plate or block having wells arranged in a differing configuration. In particular, the present invention provides systems and methods for transferring such liquid samples between a standard rectangular microtiter sample reaction/storage reaction block having wells arranged in straight rows and a circular MCP reaction plate having wells arranged in an arc. The system comprises a plurality of moveable arms, wherein each arm is adapted to hold a fluid sample dispensing tube having a distal end. The arms are positionable so that the distal ends of the held tubes can simultaneously access wells arranged in a substantially straight row, such as wells in a standard rectangular 96, 384, 1536 or 3456 well microtiter block. This allows the tubes to extract or aspirate the liquid from the wells. The arms are then repositionable or moveable so that the distal ends of the held tubes can be repositioned to simultaneously access wells arranged in an arc, such as loading wells in a circular MCP reaction plate.

The plurality of arms are transitionable between these two configurations by at least one actuator, typically by a single actuator. The actuator pivots the arms around pivot points to transition the arms between the two configurations. In a preferred embodiment, the arms are aligned in a side-by-side fashion and at least one arm is joined to another arm at a pivot point. Preferably, all of the arms are joined to each other by pivot points which are substantially aligned so that the arms pivot together. In a first configuration, the arms are vertically positioned in parallel and the distal ends are aligned along a substantially linear horizontal path. It may be noted that the position of the distal ends may vary vertically, as will be described later, to allow for different access depths in the wells. In addition, the spacing between the tubes may be uniform or may vary depending on the desired assay protocol. In a second configuration, the majority of the arms are pivoted so that the tubes are drawn together and the distal ends are aligned along an arc shaped path. Arcs of different radiuses may be achieved to provide for wells in various arc shaped arrangements. Further, the arms may be pivoted or repositioned so that the distal ends are aligned along a portion of an oval, elliptical or other curved path. In addition, it is within the scope of the present invention that the repositioned distal ends are aligned in any configuration which differs from the first configuration (i.e. linear).

The system additionally comprises a guiding system whereon the moveable arms are mounted. The guiding system typically comprises mechanisms for vertically and/or horizontally translating the arms together as a group. This allows the arms to be transported between the standard microtiter block and the MCP. In addition, the guiding system typically comprises means for individually moving at least one of the arms in relation to another arm, such as mechanisms for raising and/or lowering the distal end of a tube held by an arm independently of the other distal ends.

Prior to transporting liquid sample between the block and plate, the position of the distal ends of the dispensing tubes may be adjusted to compensate for any warping of the block. Generally microtiter blocks are comprised of a hard, polymeric material which may warp over time. Typically, the MCPs are comprised of glass so warping is generally not a concern. When microtiter blocks are warped, it is difficult to aspirate small volumes (less than 3 μl) from its wells when rigid assemblies of needles or aspiration tubes are used. Due to the uneven depths of the wells, some of the tubes hit the bottom of the wells and clog while others do not access the wells to a sufficient depth to reach the samples.

For such adjustment of the distal ends, the system may include a plurality of flexible members, each member connected to one of the plurality of arms and the tube which is mounted thereon so that the tube is positionable relative to the arm by flexure of the flexible member. In a preferred embodiment, a flexible member is positioned in a horizontal orientation relative a given tube which is positioned vertically. The member is attached to the tube and the arm which holds the tube. When an upward force is applied to the distal end of the tube, such as by contacting the bottom of the well during accessing, the tube translates upward, flexing or bending a portion of the attached flexible member. The tube may be held in this position by adjusting an adjustable device, such as an adjustment screw, which holds the flexible member in a fixed relation to the arm.

Once the position of the distal ends have been vertically adjusted to reflect any warping of the well surfaces, the tubes may be used to aspirate liquid samples from the wells of a microtiter block and expel the samples into the loading wells of an MCP. Generally, the arms are moved so that the tubes access a row of wells in the rectangular microtiter block, aspirate liquid from the wells, access a portion of wells in the MCP, and expel the liquid into the wells. The arms are then optionally moved to a cleaning station where the tubes may access cleaning wells to be cleansed of any residual fluid. The arms are then moved so that the tubes access another row of wells in the rectangular microtiter block, aspirate liquid from the wells, access another portion of wells in the MCP, and expel the liquid into the wells. The microtiter block and the MCP may remain stationary or may move or rotate to reposition the wells. Similarly, the block and/or MCP may be replaced between such accessing.

In accordance with the present invention, the individual dispensing tubes can be individually actuated to skip wells leading to clogged microchannels in the MCP and dispense in wells leading to “spare” microchannels. Specifically, if it is known that a particular sample channel is clogged, the sample which would have been loaded into the channel can instead be directed to another spare channel for analysis. When using the present preferred circular well array MCP, the plate may be rotated relative to the sample loader when re-directing one of the samples to a spare sample channel . Accordingly, although the present system is ideally suited to load a plurality of samples simultaneously, it optionally encompasses loading various samples sequentially, as desired.

The advantages of the present invention include, but are not limited to, its ability to transfer samples from wells arranged in one geometry to wells arranged in another geometry, particularly in a single operation. Such geometries may be rectangular to circular, rectangular to oval, rectangular to square or any other combination of geometries. In addition, the present invention provides for aspirating low volumes of liquid sample from a warped well plane without clogging the tubes which access the wells and without missing samples. This provides for a more accurate aspiration and dispensing of fluids from a warped plate. Other objects and advantages of the present invention will become apparent from the detailed description to follow, together with the accompanying drawings.

### BRIEF DESCRIPTION OF THE DRAWINGS

FIG. 1 is a perspective illustration of an embodiment of the fluid loading system accessing a standard rectangular microtiter block.

FIG. 2 is a perspective illustration of the fluid loading system of FIG. 1 accessing a circular MCP.

FIG. 3A is a top view illustration of the movable arms in a position for accessing wells in linear rows of a rectangular microtiter block.

FIG. 3B is a top view illustration of the movable arms of FIG. 3A repositioned for accessing wells in a curved well arrangement.

FIGS. 4A-4B reflect corresponding FIGS. 3A-3B and include a depiction of an actuation system.

FIG. 5 is a side view illustration of an embodiment showing a movable arm.

FIG. 6 is a cross-sectional illustration of a warped block with dispensing tubes positioned above the wells.

FIG. 7 is an enlarged view of a portion of FIG. 5 showing a flexible member.

FIG. 8 is a cross-sectional illustration of the warped block of FIG. 6 with dispensing tubes positioned within the wells.

FIG. 9 illustrates the flexible member flexing upon contact of the tube with the well.

FIG. 10 is a cross-sectional illustration of the warped block of FIG. 6 with dispensing tubes positioned above the wells after correction for the warping

FIG. 11 illustrates variation in the number of tubes to access only specific wells.

### DETAILED DESCRIPTION OF THE INVENTION

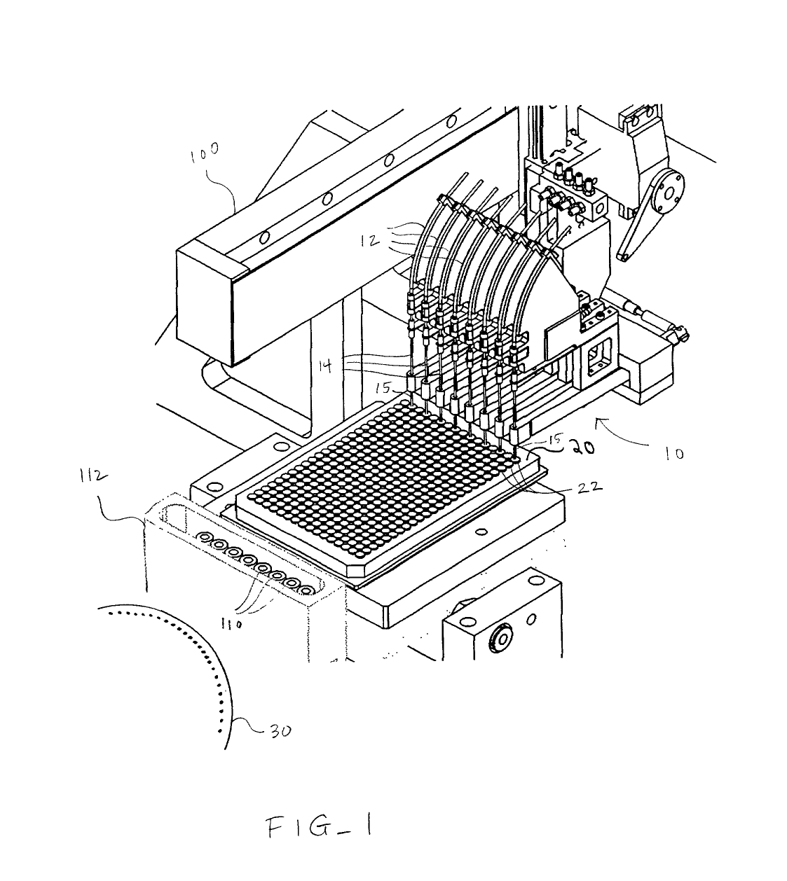

FIG. 1 illustrates a fluid loading system 10 of the present invention. The system comprises movable arms 12 which hold fluid sample dispensing tubes 14, as shown. The movable arms 12 are mounted on a guiding system 100 so that the arms 12 can be spatially positioned. In this embodiment, the tubes 14 are used to transport fluid material between a standard microtiter sample reaction/storage block 20 and a circular well array MCP reaction plate 30 by spatial movement of the arms 12. Such spatial movement includes horizontal and/or vertical gross movement of the arms 12 together as a whole between the stationary block 20 and plate 30. It may be appreciated that, alternatively, the block 20 and plate 30 may be spatially moveable to allow transport of the fluid while the arms 12 remain in a fixed location. Or, the block 20, plate 30 and arms 12 may be spatially moveable. In any case, the arms 12 themselves are manipulable to various positions, as will be described later. Any of these movements may be manually, pneumatically, electrically and/or computer controlled, to name a few.

Each tube 14 has a distal end 15 and is mounted on an arm 12 so that the end 15 protrudes beyond the arm 12. Typically, the system 10 comprises 6-8 arms 12 which are aligned in a side-by-side fashion. However, it may be appreciated that the system 10 may comprise any number of arms 12, including one to twenty or more. In addition, the arms 12 may be spaced apart by any distance, typically in the range of 0.5 to 1.5 cm. In the embodiment shown in FIG. 1, the arms 12 are aligned and spaced so that the ends 15 can easily access a row of wells 22 in the block 20. As shown, the arms 12 may be lowered so that the ends 15 access the wells 22 to aspirate or withdraw fluid from the wells 22. To transport the fluid to wells 32 of a circular well array MCP reaction plate 30, the arms 12 are then raised and transported horizontally toward the plate 30 by movement of the arms 12 along the guiding system 100. Again, it may be appreciated that the block 20 and plate 30 may be positioned in any arrangement in relation to each other and the guiding system 100 would suitably transport the arms 12 between them.

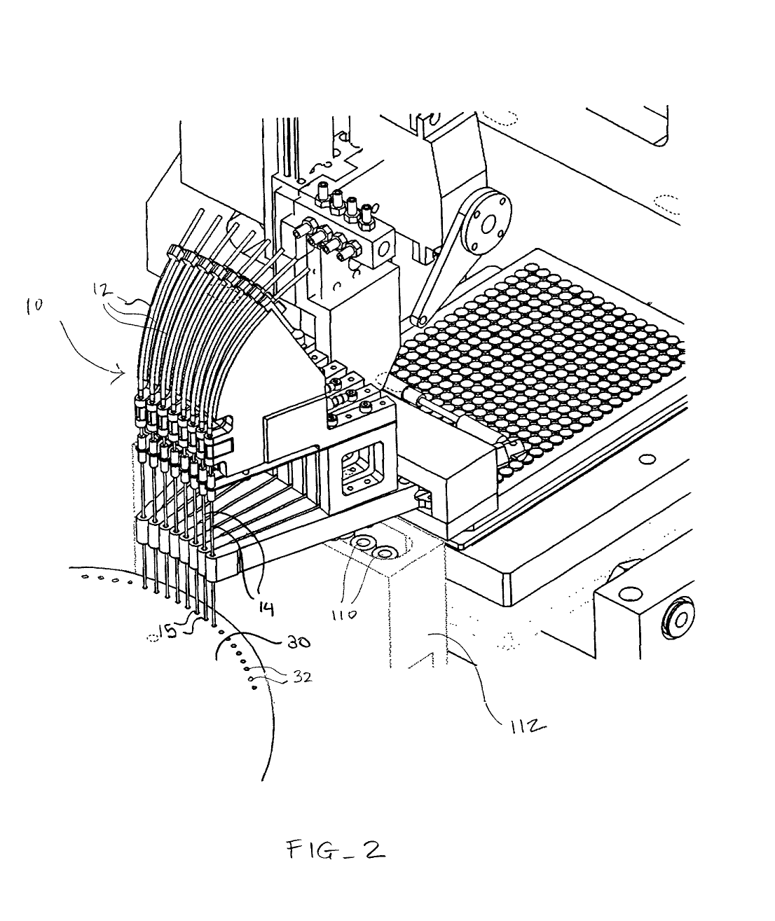

Referring to FIG. 2, the arms 12 are manipulated so that the ends 15 of the tubes 14 are arranged in an arc shape. The arc shape is to substantially match the arc shaped arrangement of the wells 32 of the plate 30 so that the wells 32 may be simultaneously accessed by the tubes 14. As shown, the ends 15 may enter the wells 32 to allow expulsion of the fluid sample into the wells 32. The arms 12 may again be manipulated and translated to access cleaning wells 110 of a cleaning station 112. Here the tubes 14 may be cleansed of any residue fluid material. The arms 14 may then be returned to access additional wells 22 of the block 20 for transfer of material to another set of wells 32 in the plate 30. This may be repeated any number of times and the block 20 and/or plate 30 may be moved, rotated or replaced.

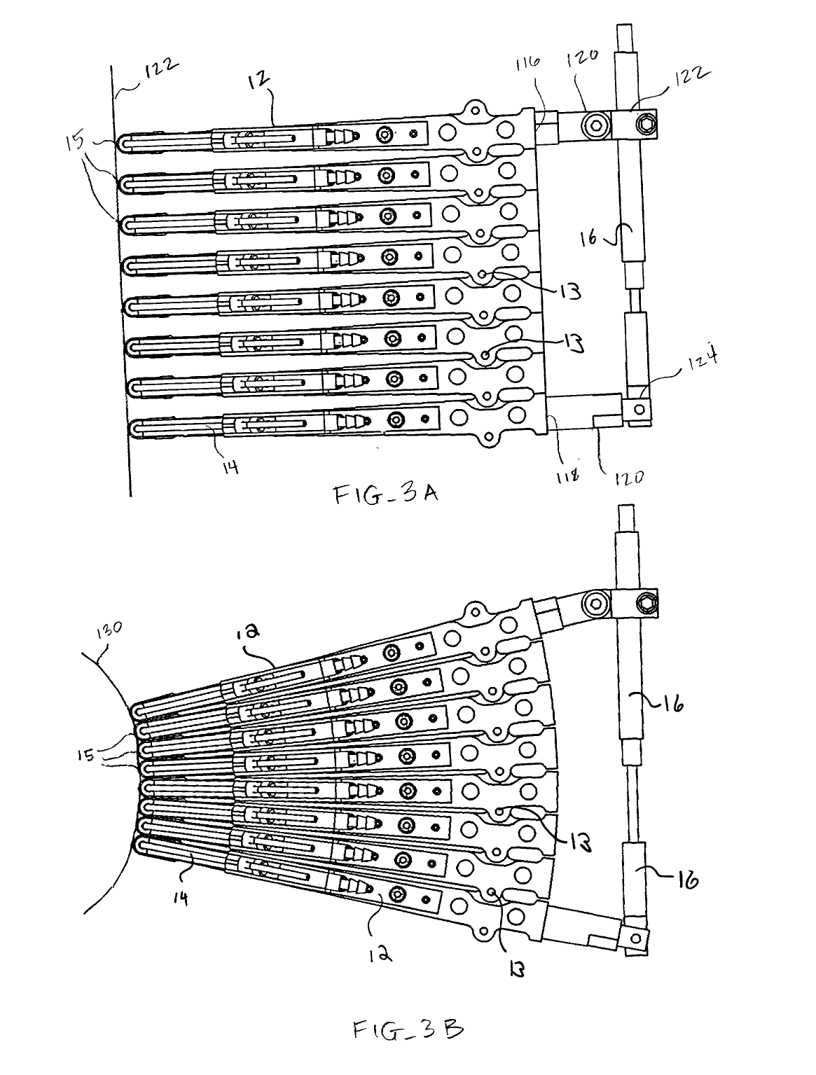

Positioning of the moveable arms 12 can preferably be accomplished with a single actuator. For example, as shown in FIGS. 3A-3B, a pneumatic cylinder 16 can be used. As shown, the arms 12 are joined to each other at pivot points 13 and the pneumatic cylinder 16 is connected to the arms 12 at at least two locations 116, 118. Here, extensions 120 are used to connect the arms 12 at the two locations 116, 118 to the cylinder at locations 122, 124. As shown in FIG. 3A, the arms 12 may be positioned such that the distal ends 15 of the tubes 14 are aligned along a substantially straight line 122. As shown in FIG. 3B, the cylinder 16 may be extended which increases the distance between location 122 and location 124. This, in turn, causes the arms 12 to pivot around the pivot points 13 and the ends 115 to move toward each other and align along an arc or curved line 130. Thus, FIG. 3A reflects the position of the arms 12 when accessing wells 22 in linear rows of a standard rectangular microtiter sample reaction/storage reaction block 20 as shown in FIG. 1. And, FIG. 3B reflects the position of the arms 12 when accessing wells 32 of an MCP reaction plate 30 wherein the wells 32 have a circular or curved well arrangement, as shown in FIG. 2.

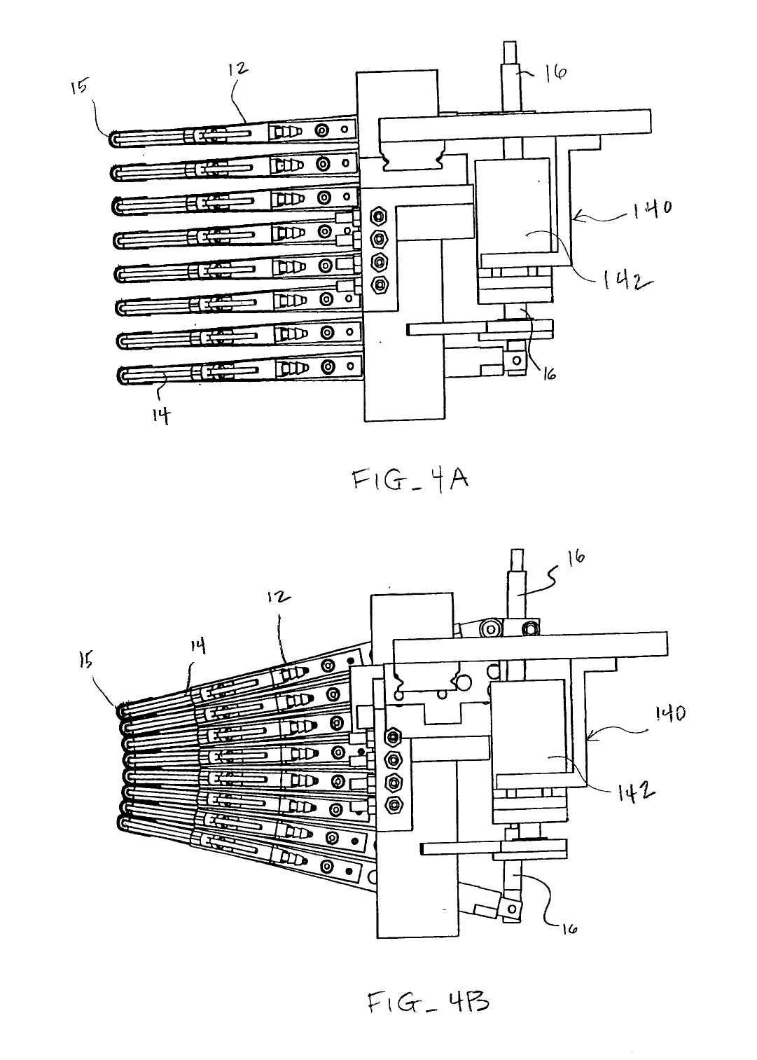

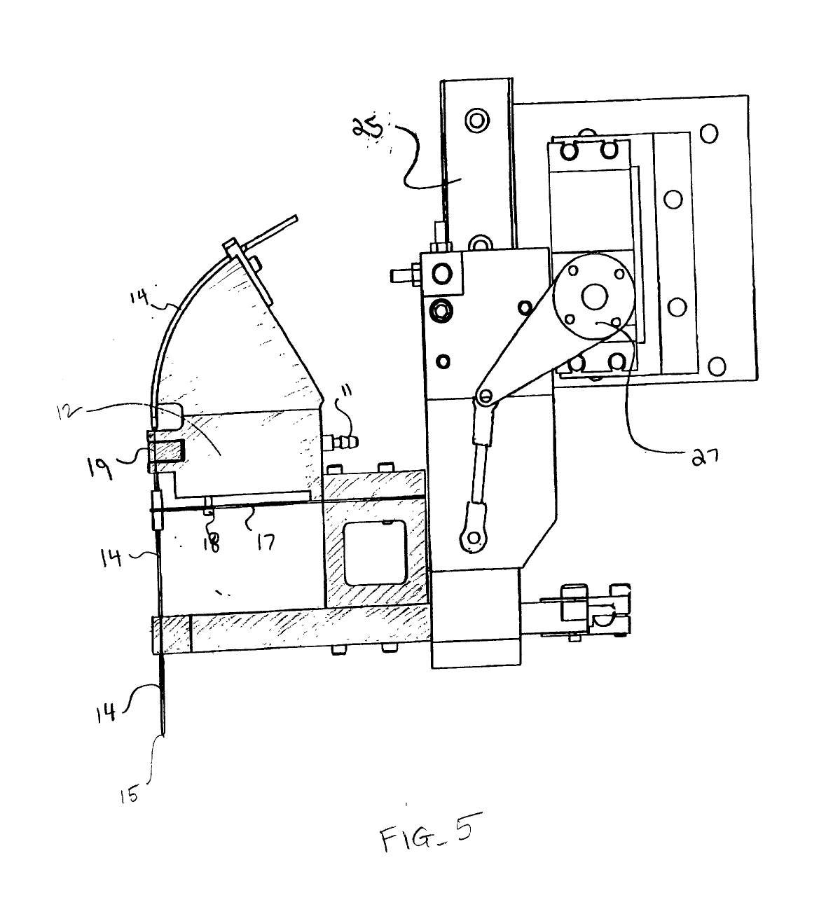

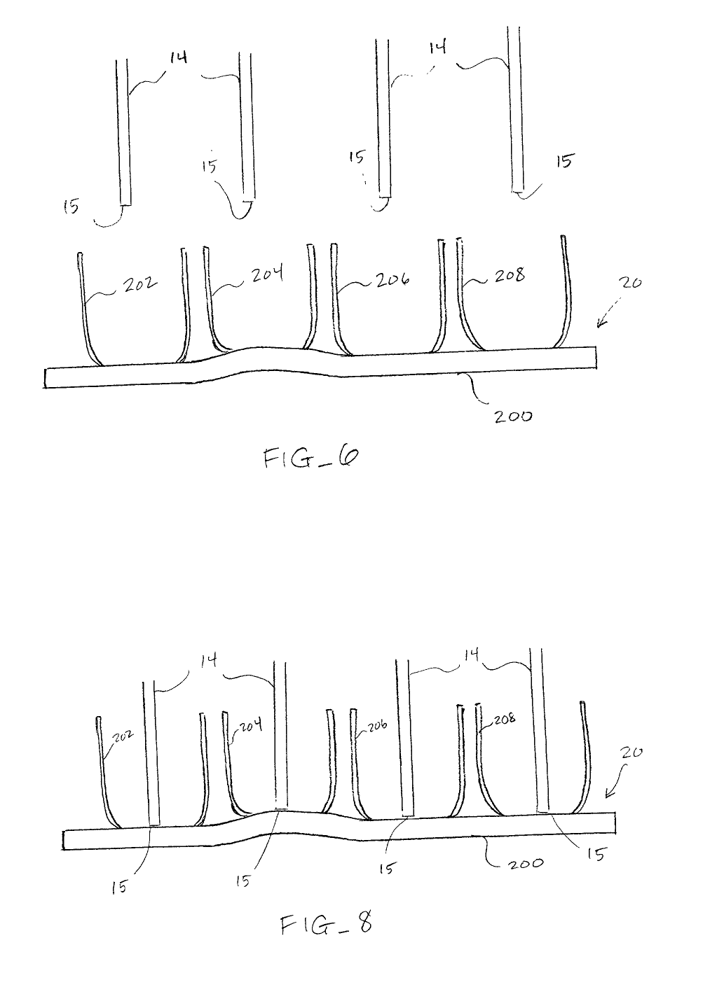

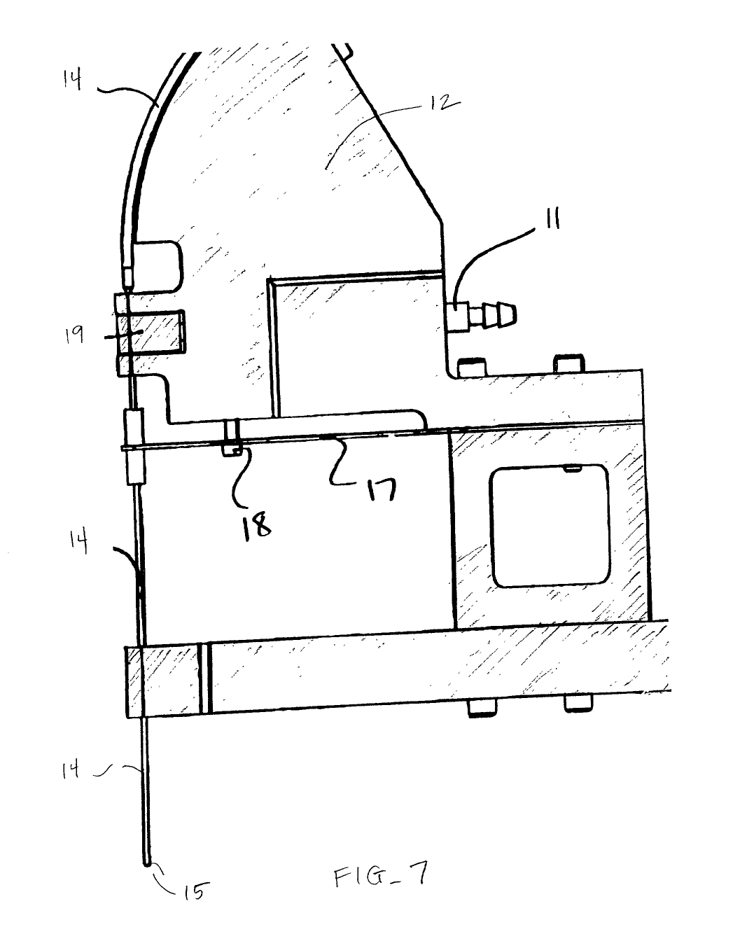

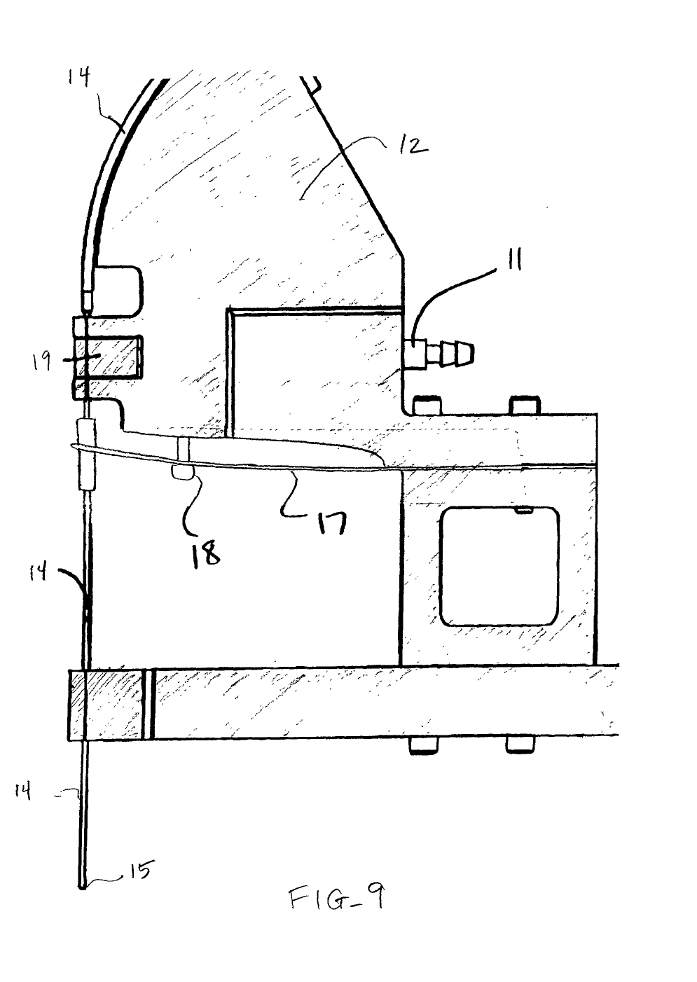

FIGS. 4A-4B reflect corresponding FIGS. 3A-3B and include a depiction of an actuation system 140, a portion of the guiding system 100 which is connected the arms 12. As shown, the actuation system 140 may include a motor 142 which drives a variety of mechanisms to manipulate the arms 12. However, in other embodiments, the motor 142 is not included and mechanisms are manually driven or driven by solenoids, for example. As illustrated in FIG. 5, the vertical height of the arms 12 as a whole can be adjusted, i.e. moved upwardly or downwardly together, by a motorized arm 27. The motorized arm 27 slides the arms 12 along a linear guide 25, allowing the arms 12 to be positioned at any height. Alternatively, the arms 12 may be manually lowered and then raised by action of a pneumatic piston. In addition, the vertical height of ends 15 of each of the tubes 14 can be individually positioned. This may be particularly useful in accommodating blocks 20 having warped wells 22.

Individual positioning of the arms 12 and/ or tubes 14 is useful in correcting for warping in blocks 20. FIG. 6 illustrates in cross-section an example of a warped block 20. Here, the block 20 has a base 200 and four wells 202, 204, 206, 208. The base 200 is warped so that well 204 is slightly raised in relation to the other wells 202, 206, 208. Four tubes 14 are illustrated ready to access the wells. The tubes 14 are typically positioned so that the ends 15 are aligned. As shown in FIG. 5, the vertical position of the tubes 14 may be adjusted by an adjustment device 18, such as an adjustment screw. FIG. 7 provides a slightly enlarged view of a portion of FIG. 5 for clarity. In this embodiment, the tube 14 is connected with one end of a spring or flexible member 17. The opposite end of the flexible member 17 is fixedly attached to the arm 12. Therebetween, the member 17 is connected with a portion of the arm 12 by the adjustable device 18. Referring now to FIG. 8, the tubes 14 are then lowered so that the ends 15 contact the bottom surface of the wells 202, 204, 206, 208 as shown. The end 15 in well 204 is will contact the bottom surface of well 204 before the other ends 15. As the ends 15 are further lowered, a force is applied to the end 15 in well 204 by the bottom surface. As shown in FIG. 9, this force causes the tube 14 to bend the flexible member 17 upward. This allows the tube 14 to move in relation to the arm 12. Thus, the tube 14 accessing well 204 is raised slightly in relation to the other tubes. This is continued until the remainder of the ends 15 contact the bottom surface of the wells. At this point, adjustable device 18 may then be adjusted to lock the flexible member 17 in place. When the device 18 comprises an adjustment screw, such adjustment involves turning the screw. In addition, the tubes 14 may be locked into position using a locking mechanism 19 which may optionally be actuated by a pneumatic cylinder 11 or a motor (not shown).

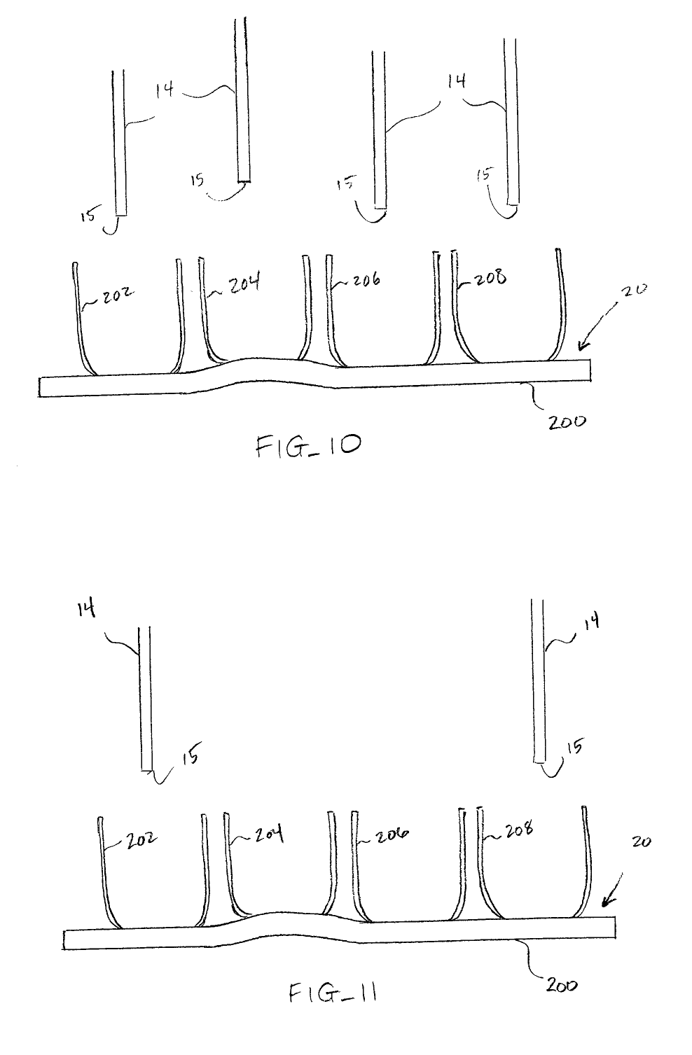

Referring to FIG. 10, upon withdrawal of the tubes 14 from the wells 202, 204, 206, 208 the tube 14 from well 204 is slightly raised so that it's end 15 is no longer aligned with the other ends 15. Thus, the positioning of the tubes 14 have been corrected for the warping of the block 20. The arms 12 may then be used as illustrated in FIGS. 1-2 to transfer fluids between a warped block 20 and a plate 30. Such correction for warping may be carried out between each transfer, i.e. so that warping in each row of wells 22 is individually corrected for. Or, such correction for warping may be determined for a portion of the block 20 having the most dramatic warping and the arms 12 remaining in this corrected arrangement throughout the transfer of fluid between the entire block 20 and the plate 30. This correction feature, alone or in combination with individual arm 12 height adjustment, improves accuracy in aspirating and/or dispensing fluids from a warped plate, reduces the incidence rate of missing samples by not allowing certain tubes to enter the wells to a sufficient depth and reduces the frequency of clogging tubes due to contact with plate. Thus, the present invention has an improved ability to aspirate low volumes of less than 3 μl from warped sample blocks and thereby dispense low volumes of less than 1 μl.

It may be appreciated that a variety of embodiments may reflect the system 100 and are within the scope of the present invention. For example, the number of arms 12 may vary to accommodate the number of wells in the block 20 or plate 30, to accommodate the aims of the loading procedure, or for any other reason. Similarly, the number of tubes 14 may be varied instead of or in addition to the number of arms 12. For example, tubes may be withdrawn from the arms 12 so, for example, as illustrated in FIG. 11, the center wells 204, 206 are not accessed while the surrounding wells 202, 206 are accessed by tubes 14. This may be accomplished by removing or sufficiently raising the tubes 14 within the arms 12. Further, the arms 12 may be spaced apart by any amount to accommodate blocks 20 and/or plates 30 having different numbers and sizes of wells. In addition, the arms 12 may be pivoted around pivot points 13 or other pivot points so that the ends 15 access wells arranged along a straight line or curved arc of any radius. Such an arc may reflect a portion of a circle, oval, ellipse or other curved shape. Likewise, the pivot points may be positioned such that the ends 15 of the tubes 14 follow an “S” shaped curve or other varying curve before and/or after pivoting.

The present invention may also encompass additional features. For example, a plurality of sample dispensing tubes may be supported in an “in-line” configuration on each of the movable arms of the sample loader. Each of the plurality of dispensing tubes on each movable arm may preferably dispense a different sample, with the plurality of dispensing tips (i.e. tubes) aligning with curved well arrays of different diameter. Such a plurality of in-line dispensing tips will advantageously increase system throughput. For example, each additional row of tips will double throughput of the sample loading.

Although the foregoing invention has been described in some detail by way of illustration and example, for purposes of clarity of understanding, it will be obvious that various alternatives, modifications and equivalents may be used and the above description should not be taken as limiting in scope of the invention which is defined by the appended claims.

What is claimed is:

1. A fluid sample loading system comprising:
a plurality of moveable arms wherein each arm is adapted to hold a fluid sample dispensing tube having a distal end, and wherein the arms are positionable so that the distal ends of held tubes can simultaneously access wells arranged in a substantially straight row and moveable so that the distal ends of held tubes can simultaneously access wells arranged in an arc.

2. A system as in claim 1, wherein at least one arm is joined to another arm at a pivot point.

3. A system as in claim 2, wherein the at least one arm is connected to an actuator which pivots the at least arm around the pivot point.

4. A system as in claim 3, wherein the actuator comprises a pneumatic cylinder.

5. A system as in claim 3, wherein the actuator comprises a motor.

6. A system as in claim 1, wherein the plurality of moveable arms comprises three or more moveable arms.

7. A system as in claim 6, wherein the plurality of moveable arms comprises eight moveable arms.

8. A system as in claim 1, wherein spacing between the plurality of moveable arms is adjustable.

9. A system as in claim 1, further comprising a guiding system to which the plurality of moveable arms are mountable.

10. A system as in claim 9, wherein the guiding system comprises means for vertically and/or horizontally translating the arms together as a group.

11. A system as in claim 9, wherein the guiding system comprises means for individually moving at least one of the arms in relation to another arm.

12. A system as in claim 11, wherein the means for individually moving comprises means for raising and/or lowering the distal end of a tube held by the at least one arm.

13. A fluid sample loading system comprising:
a plurality of moveable arms wherein each arm is adapted to hold one of the plurality of tubes,
a plurality of fluid sample dispensing tubes, each tube having a distal end and mounted on a moveable arm;
a plurality of flexible members, each member connected to one of the plurality of arms and the tube which is mounted thereon so that the tube is positionable relative to the arm by flexure of the flexible member.

14. A system as in claim 13, wherein the tube which is mounted thereon is positioned in a vertical orientation and the flexible member is positioned in a horizontal orientation so that flexure of the flexible member comprises vertical movement of at least a portion of the member to vertically position the distal end of the tube.

15. A system as in claim 13, further comprising an adjustable device connectable with the flexible member and the moveable arm, wherein the adjustable device holds the member in a fixed relation to the arm.

16. A system as in claim 15, wherein the adjustable device comprises an adjustment screw.

17. A system as in claim 13, further comprising a locking mechanism which locks the tube in fixed relation to the arm.

18. A method of transferring fluid samples comprising:
providing a fluid sample loading system comprising a plurality of moveable arms wherein at least one of the arms holds a fluid sample dispensing tube having a distal end;
positioning the arms so that the distal ends of the held tubes can simultaneously access wells arranged in a substantially straight row; and
repositioning the arms so that the distal ends of the held tubes can simultaneously access wells arranged in an arc.

19. A method as in claim 18, wherein at least one arm is joined to another arm at a pivot point and positioning the arms comprises pivoting the at least one arm in relation to the another arm.

20. A method as in claim 18, wherein at least one arm is joined to another arm at a pivot point and repositioning the arms comprises pivoting the at least one arm in relation to the another arm.

21. A method as in claims 19 or 20, wherein the system further comprises an actuator and pivoting comprises activating the actuator to induce pivoting.

22. A method as in claim 18, wherein positioning comprises vertically and/or horizontally translating the arms together as a group.

23. A method as in claim 18, wherein repositioning comprises vertically and/or horizontally translating the arms together as a group.

24. A method as in claim 18, wherein positioning comprises individually moving at least one of the arms in relation to another arm.

25. A method as in claim 18, wherein repositioning comprises individually moving at least one of the arms in relation to another arm.

26. A method as in claim 18, further comprising simultaneously accessing the wells arranged in the substantially straight row by lowering the distal ends of the held tubes so that they are positioned within the wells.

27. A method as in claim 26, wherein the wells arranged in the substantially straight row comprise a portion of a rectangular microtiter sample reaction block.

28. A method as in claim 26, wherein at least one of the wells arranged in the substantially straight row holds a liquid sample, the method further comprising aspirating at least a portion of the liquid from the well into the tube accessing the well.

29. A method as in claim 28, further comprising simultaneously accessing the wells arranged in the arc by lowering the distal ends of the held tubes so that they are positioned within the wells.

30. A method as in claim 29, wherein the wells arranged in the arc comprise a portion of a circular microchannel plate.

31. A method as in claim 29, the method further comprising expelling at least a portion of the liquid from the tube accessing the well into the well.

32. A method of adjusting a fluid sample loading system to access an uneven microtiter block, said method comprising:
providing the fluid sample loading system comprising a plurality of moveable arms wherein at least one of the arms holds a fluid sample dispensing tube having a distal end;
positioning the tube within a well of the microtiter block so that the distal end contacts a surface of the well with sufficient force to displace the tube to a displaced position; and
holding the tube in the displaced position.

33. A method as in claim 32, wherein holding the tube in the displaced position comprises activating a locking mechanism.

34. A method as in claim 32, wherein the arm further comprises a flexible member and displacement of the tube comprises flexure of the flexible member.

35. A method as in claim 32, wherein the well holds a liquid sample and the method further comprising:
accessing the well by lowering the distal end of the tube held in the displaced position; and
aspirating at least a portion of the liquid.
